(19) United States
(12) Patent Application Publication
(10) Pub. No.: US 2011/0205603 A1
(43) Pub. Date: Aug. 25, 2011

(54) SHEET-FED LAPTOP SCANNER

(76) Inventors: Shifrin Rafael, Netanya (IL); Piotr Drugac, Netanya (IL)

(21) Appl. No.: 12/979,377

(22) Filed: Dec. 28, 2010

(30) Foreign Application Priority Data
Jan. 19, 2010 (IL) 203380

(51) Int. Cl. H04N 1/04

(52) U.S. Cl. 358/483; 358/498; 358/482

(57) ABSTRACT

A sheet fed scanner integral to a laptop computer including a scanning apparatus embedded in the hinged edge of the monitor and a roller assembly embedded in the body of the laptop. The medium to be scanned is fed below the scanning medium by the roller assembly and scanned by the scanning apparatus.

This patent application claims the benefit of Israeli Patent Application No. 203380, filed Jan. 19, 2010

### FIELD AND BACKGROUND OF THE INVENTION

The present invention relates to a scanner for a laptop computer and, more particularly, to a scanner assembly incorporated into the body of a laptop computer.

The current invention incorporates a scanning component in the base of a laptop monitor and a set of rollers in the body of the laptop. The innovative configuration provides an opening between the monitor and body of the laptop through which a piece of paper is fed by the rollers. While passing beneath the base of the monitor, the embedded scanner scans the page, storing the digital image on the laptop.

Various attempts have been made to provide a scanner incorporated into a computer, a keyboard and a laptop. U.S. Pat. Nos. 5,115,374, 5,841,553, DE 102005009723 B4, DE 102004008690 B3 and U.S. Pat. App. No. 2005/0179962 A1 all describe scanners attached to, or incorporated in, the body of the computer, laptop or computer accessory. The aforementioned documents are incorporated by reference as though fully set forth herein. In each of the aforementioned documents, the described innovations suffer from similar drawbacks, namely: the scanning apparatus adds height and significant weight to the device and/or necessitates the feeding of page through a significant portion of the body of the device. The former drawback is antithetical to the current trend of minimizing the height and weight of a laptop to increase mobility and aesthetic allure. The latter drawback necessitates a significant structural change to the body of the laptop, numerous additional elements (e.g. rollers) and most likely results in numerous difficulties due to paper, jams (as are well known to anyone who has ever user a copier machine).

It would be highly advantageous to have a scanner embedded in a laptop which does not add a significant ‘footprint’ to the device, neither from the point of view of weight, not height. It would furthermore be advantageous to have a scanning apparatus where the scanned page does not pass through the body of the device.

### SUMMARY OF THE INVENTION

According to the present invention there is provided a sheet-fed laptop scanner including: (a) a scanning apparatus embedded in the hinged edge of a laptop monitor; and (b) a roller assembly operationally coupled to a laptop body, whereby the roller assembly is operative to propel a page over the roller assembly and beneath the scanning apparatus and through an aperture defined between the laptop body and the laptop monitor.

According to further features of the embodiment, the scanning apparatus includes: (i) a scanner lamp for illuminating the medium while the roller assembly propels the medium beneath the scanning apparatus; (ii) an image sensor; and (iii) an optical system for projecting an illuminated image from the illuminated medium onto the image sensor.

According to still further feature the image sensor is a Charge-Coupled Device (CCD) array or a Contact Image Sensor (CIS).

According to further features, the roller assembly includes a motor and at least one roller operationally coupled to the motor.

According to further features, the scanner includes a monitor position locator, for accurately positioning the laptop monitor substantially perpendicular to the laptop body, to enhance scanning quality. The monitor position locator may include a threaded hinge clickably delineating the substantially perpendicular position. Alternatively, the position locator may include at least one reference indicator for indicating that the laptop monitor is in the desired substantially perpendicular position. The at least one indicator may be digitally displayed on the monitor. Alternatively, the at least one indicator may be located on the laptop computer.

### BRIEF DESCRIPTION OF THE DRAWINGS

Various embodiments are herein described, by way of example only, with reference to the accompanying drawings, wherein:

FIG. 1a-e depict various views of one embodiment the invention with an exemplary sheet of paper partially protruding through the opening;

FIG. 2a-c depict various views of the monitor section of one embodiment the invention;

FIG. 3a-d depict various views of the body section of one embodiment the invention;

FIG. 4a-e depict various views of a second embodiment the invention with an exemplary sheet of paper partially protruding through the opening;

FIG. 5a-c depict various views of the monitor section of a second embodiment the invention;

FIG. 6a-d depict various views of the body section of a second embodiment the invention;

FIG. 7 is a schematic block diagram of the invention.

### DESCRIPTION OF THE PREFERRED EMBODIMENTS

The principles and operation of a sheet-fed laptop scanner according to the present invention may be better understood with reference to the drawings and the accompanying description.

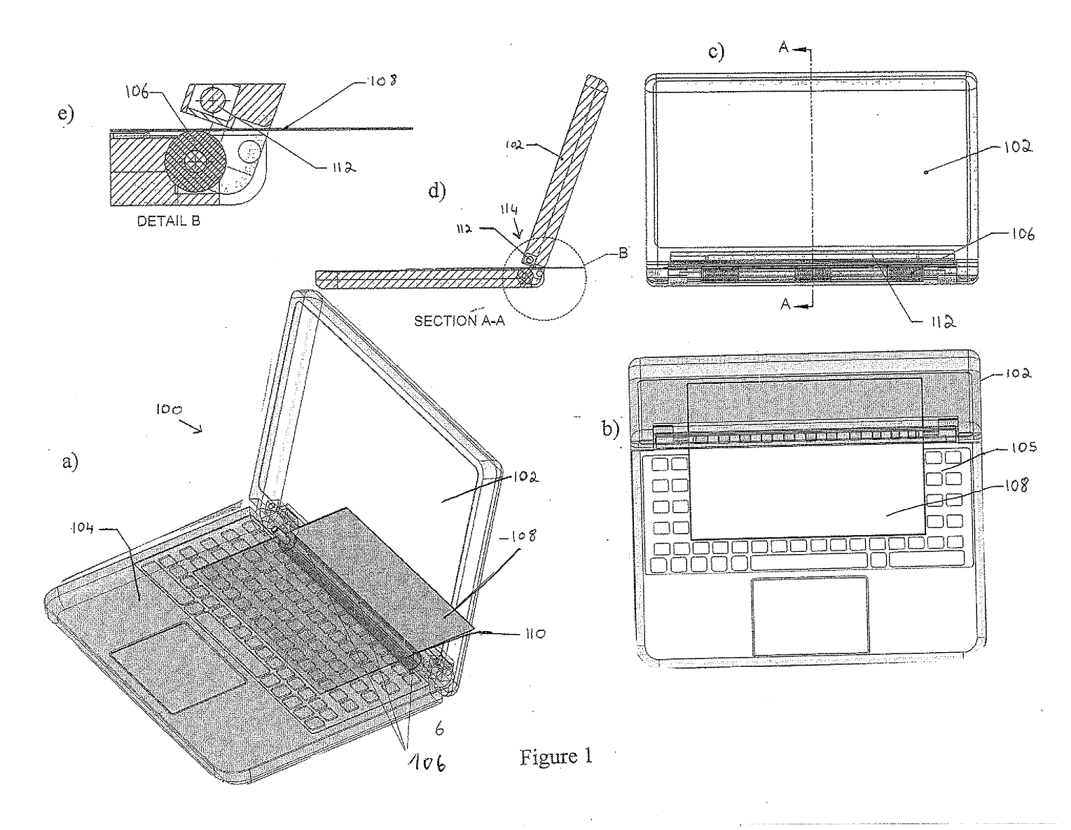

Referring now to the drawings, FIG. 1 a illustrates an isometric back view of a laptop 100 with an exemplary sheet of paper 108 partially protruding through opening 110 defined by monitor section 102 and body section 104 of the laptop. The paper is propelled by a set (three in the current embodiment) of rollers 106. FIG. 1b is a top view of laptop 100 with partially fed sheet 108 partially transparently depicted above keyboard 105. FIG. 1c is a back view of laptop 100 delineating section A-A and FIG. 1d depicts a side/profile view of section A-A of the laptop. Scanning lamp 112 and roller assembly 106 are visible. Scanning apparatus 114 is visible, embedded in the bottom, hinged, edge of monitor 102. FIG. 1e is a magnified illustration of detail B of FIG. 1d. The current embodiment of the invention, scanning apparatus 114 includes scanning lamp 112. Scanning lamp 112 is typically a cold cathode fluorescent lamp (CCFL) or xenon lamp. Potentially a standard fluorescent lamp can also be employed. In the current embodiment, scanning apparatus 114 includes an image sensor array (not shown). Exemplarily, the image sensor array is Charge-Coupled Device (CCD) array

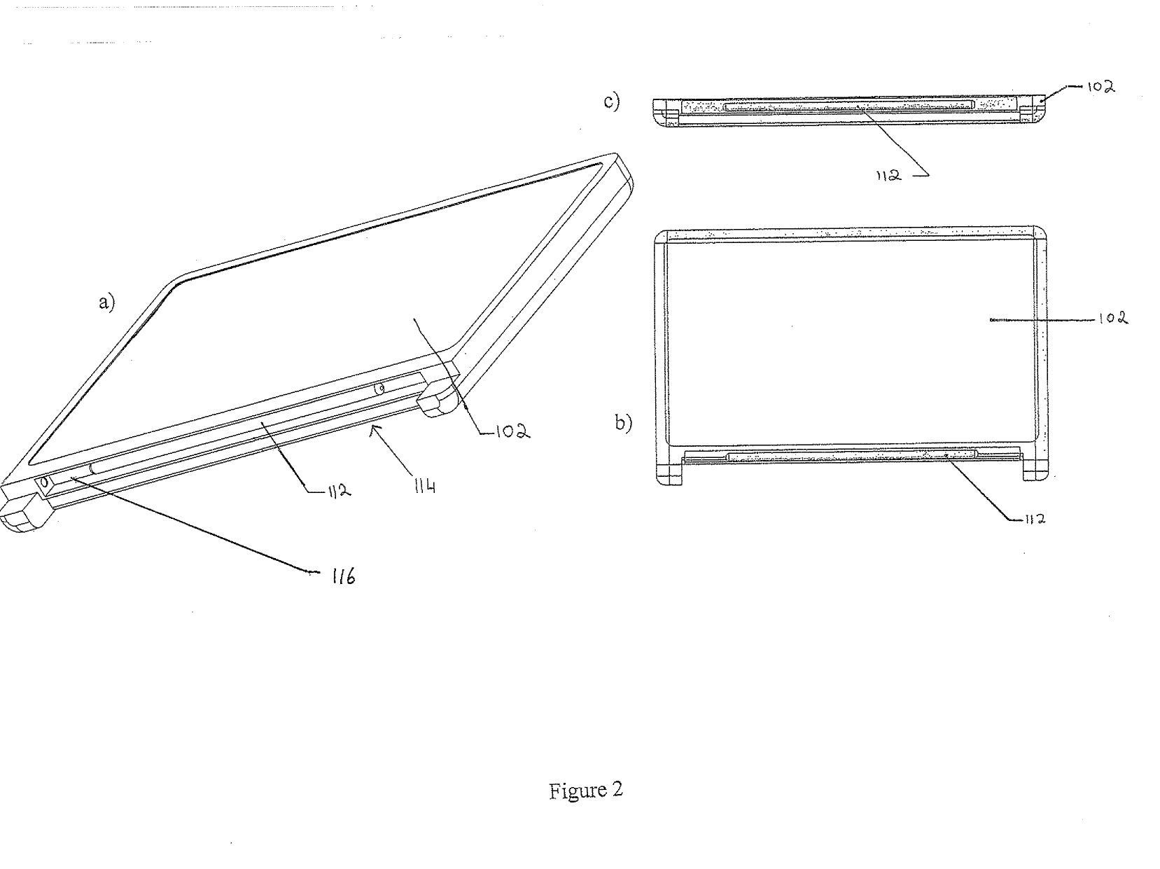

FIG. 2a depicts an isometric bottom view of the monitor section of an embodiment of the invention. Scanning lamp 112 is embedded in the bottom section of the monitor. Transparent cover 116 protects the lamp from damage. FIG. 2b is a back view of monitor section 102 of the current embodiment on the invention. FIG. 2c is a bottom view of monitor section 102 where scanning apparatus 114 is visible, including scanning lamp 112.

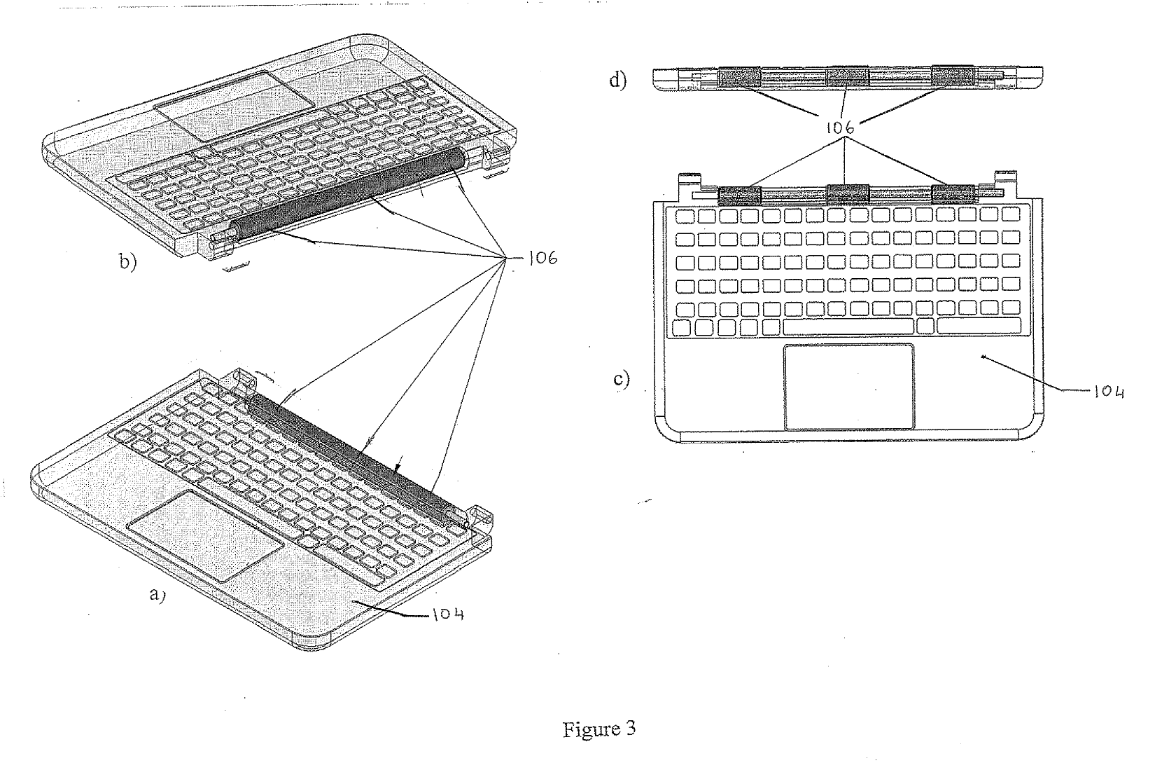

FIG. 3a is an isometric front view of body section 104 of the current embodiment of the invention. FIG. 3b is an isometric back view of body section 104. Roller unit 106 is clearly depicted herein. FIG. 3c is a top view of body section 104 and FIG. 3d is a back view of body section 104.

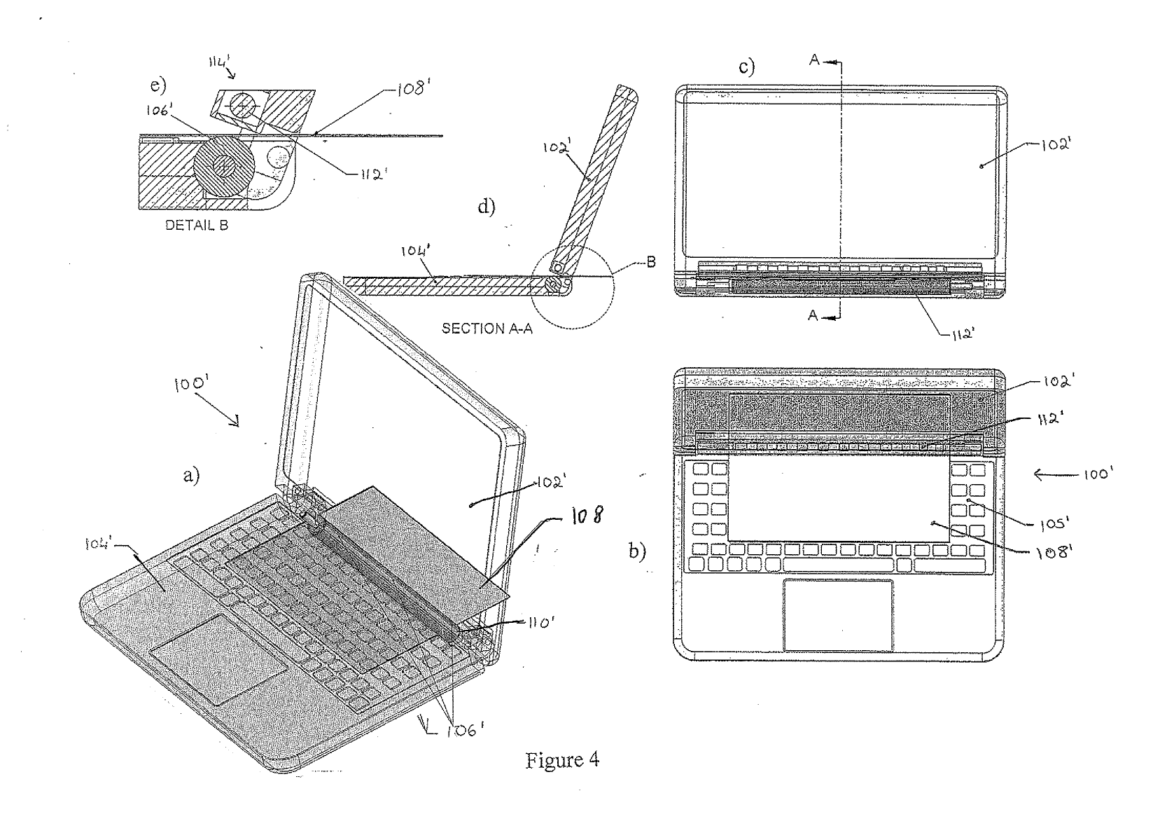

FIG. 4a depict an isometric back view of a second embodiment the current invention. Roller unit 106′ and exemplary page 108′ are visible through phantom body section 104′of the second embodiment of the invention. Page 108′ is passing over roller unit 106′ and under monitor section 102′ on the current embodiment. In the current embodiment a single roller 106′ is spans substantially the entire length of aperture 110′ and functions in a manner similar to that of roller unit 106.

FIG. 4b is a top view of laptop 100′ with partially fed sheet 108′ partially transparently depicted above keyboard 105′. Scanning Light Emitting Diode (LED) array 112′ is visible through phantom monitor section 102′. FIG. 4c is a back view of laptop 100′ delineating section A-A is seen in profile in FIG. 4d. A magnified depiction of detail B is shown in FIG. 4e. Roller unit 106′, scanning apparatus 114′ and LED array 112′ are all seen here in profile.

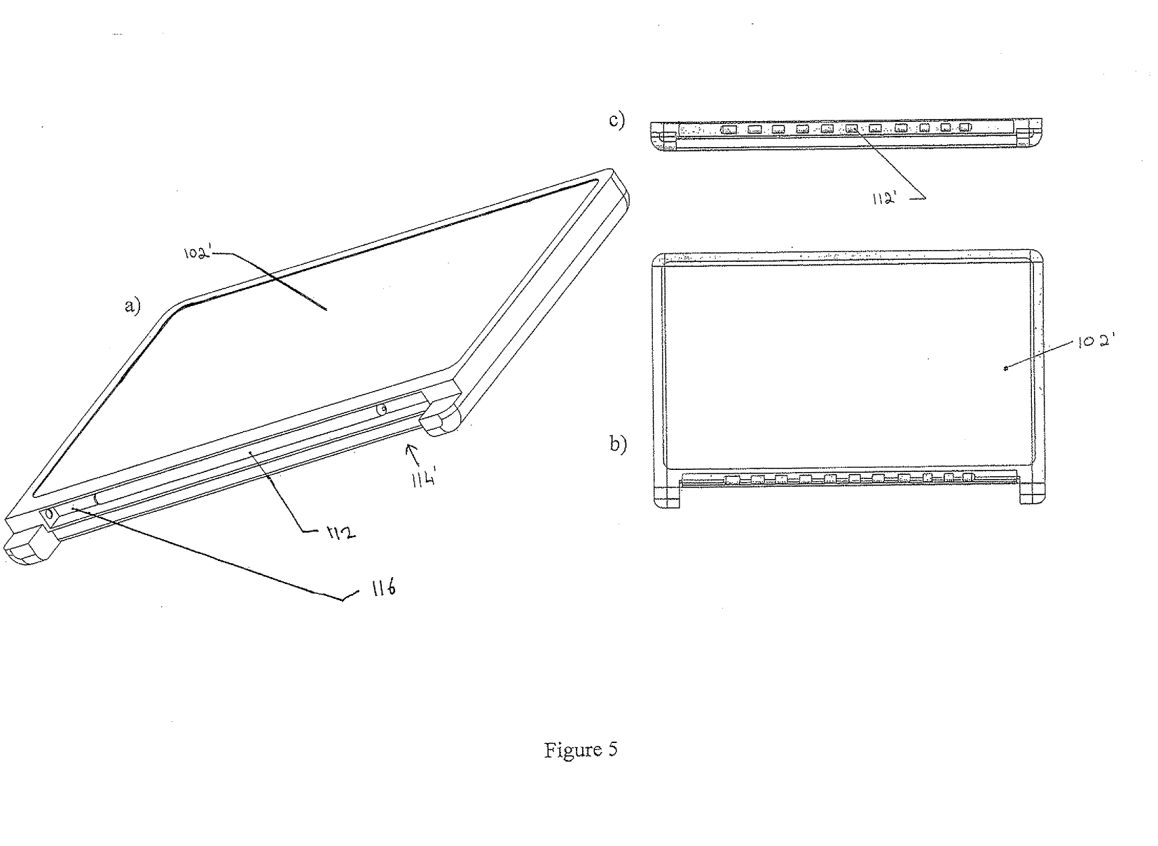

FIG. 5 is an isometric bottom view of monitor section 102′ of the second embodiment. Scanning LED array 112′ are embedded in the bottom, hinged section of the monitor. Transparent cover 116′ protects the LEDs from damage. In the second embodiment, the scanning apparatus includes an imaging sensor (not shown). Exemplarily, the imaging sensor is a Contact Image Sensor (CIS). A CIS typically consists of a linear array of detectors, covered by a focusing lens and flanked by red, green, and blue LEDs for illumination. The image sensor is in near direct contact with the object to be scanned, negating the need for mirrors. FIG. 5b is a back view of monitor section 102′ while FIG. 5c is a bottom view of the monitor section.

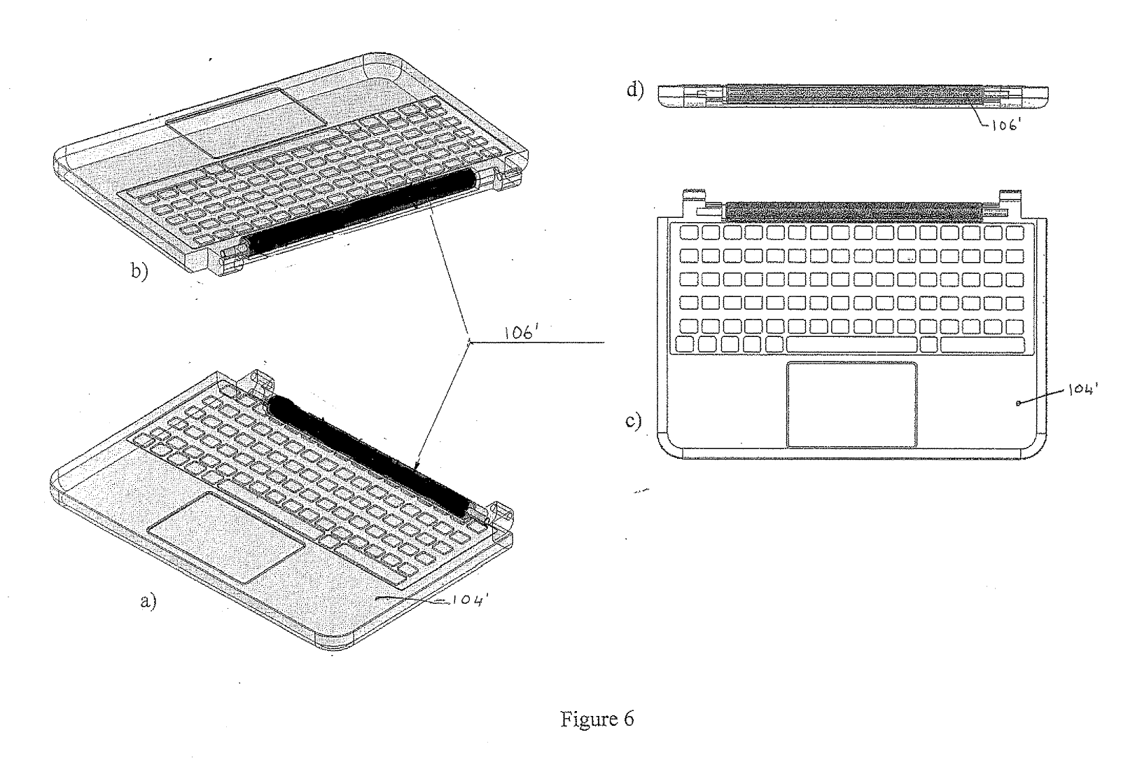

FIG. 6a is an isometric front view of body section 104′ of the current embodiment of the invention. FIG. 6b is an isometric back view of body section 104′. Roller unit 106′ is clearly depicted herein. FIG. 6c is a top view of body section 104′ and FIG. 6d is a back view of body section 104′. It is clear the rollers 106 and roller 106′ can be interchangeably used so that rollers 106 can be substituted for roller 106′ in laptop 100 and visa versa.

A further potential embodiment includes is a flying spot scanning apparatus. is U.S. Pat. No. 5,840,553 to Neukermans, which is incorporated by reference for all purposes as if fully set forth herein, teaches various configurations of extremely thin scanning apparatuses. U.S. Patent App. No. 2005/0179962 to Williamson, which is incorporated by reference for all purposes as if fully set forth herein, also teaches various configurations of compact optical scanheads.

The roller assembly includes rollers 106, 106′ and a motor (not shown) which drives the rollers. The rollers propel paper sheet 108, 108′ from the keyboard side, over the rollers and beneath the scanning apparatus 114, 114′ which provides frictional resistance to ensure the smooth progression of the sheet of paper through aperture 110, 110′, eventually coming to rest behind the laptop.

The scanned image is stored on the laptop and viewable on the monitor. Potentially, optical character recognition (OCR) software, image enhancement software and various other software utility programs can be stored on the laptop. The scanner is activated and controlled by software, firmware, hardware or any applicable combination thereof. Functions include, but are not limited to: multiple sheet scanning into a single file, high resolution scanning (e.g. for photographs), color scanning, black and white scanning, low resolution scanning etc.

In FIGS. 1 and 4 the monitor 102, 102′ is depicted in the open position at a more-than-90° angle relative to the body 104, 104′. In actuality, the optimal position for scanning apparatus 114, 114′ is perpendicular to the paper, i.e. when monitor 102, 102′ is at a 90° angle relative to body 104, 104′. To assist a user in finding the optimal position for the scanning apparatus, a monitor-position-locator can be employed. The monitor position locator can come in many configurations. One possible configuration is a clickably delineated position along the arc of rotation of the monitor. The hinge or rotational mechanism including a ball screw which, at the desired position, clicks into a reciprocal notch in the hinge provides rotational resistance force and makes a characteristic “clicking” sound. Another possible configuration is a visual guide with a set of indicators which, when correctly positioned, indicate that the monitor is in the correct position. These indicators can be physical indentions on the monitor and body, markings or a digital representation displayed on the monitor based on sensed location. Of course, any configuration of the monitor position locator which would be obvious to one skilled in the art, is considered to be included herein.

FIGS. 3 and 6 depict various views of the laptop body 104, 104′. Rollers 106, 106′ are clearly visible in this illustration. The rollers 106, 106′ are operationally coupled to a motor (not shown) housed in the body of the laptop. In one embodiment, the laptop draws power from the power source of the laptop. Alternatively, the motor can have a dedicated power source. The roller unit, including the rollers, motor, hardware, firmware and software are all embedded in the body of the laptop and form an integral part of the laptop system. The roller unit is coupled to the bus connecting the unit to other components of the laptop. The memory includes code modules for operating the scanner, the rollers, regular functions and malfunctions such as, but not limited to, misfeeds, lamp burnout, correct monitor positioning etc.

A user desiring to scan a sheet of paper positions the paper above the keyboard, on the rollers, between the boundaries defined by the hinges. The scanner is activated by a switch or button on the laptop. Alternatively or additionally, the scanner is activated via a utility program on the laptop. Once activated, the motor causes the roller to rotate, propelling the sheet of paper through the aperture defined between the monitor of the laptop, the body of the laptop and the two hinges which connect the monitor to the body. Multiple pages can be fed through the scanner within a predefined time period between each page in order to include all the pages in a single document. Photographs and other pieces of paper can be fed through the scanner. Potentially, a sensor can be integrated into the system to sense a sheet of paper being fed into the scanner area and automatically activate the scanner and scanner affiliated programs.

In one embodiment, the distance between the abovementioned hinges is sufficiently great so as to allow an A4-size page, in portrait orientation, to pass through the aperture defined by the body of the laptop, the monitor and the two hinges. In a second embodiment, the distance between the hinges is sufficiently great so as to allow an A4-size page, in landscape orientation, to pass between the hinges. In a further embodiment the distance between the hinges is sufficiently great so as to allow a letter-size page, in portrait orientation, to pass between the hinges.

FIG. 7 is a schematic block diagram of the invention. Laptop 700 includes a monitor section 702 and a body section 704 coupled together by a pair of hinges 718. Monitor section 702 includes a display monitor and scanning apparatus 714 integrated into the hinged edge of the monitor. The scanning apparatus 714 includes lamp 712 or other appropriate illuminating device such as, but not limited to, an LED array. Furthermore, the scanning apparatus includes an imaging sensor 715 such as, but not limited to, a CCD, CIS, and other devices known in the art. Additionally, an optical system 716 including, but not limited to, mirrors, lenses and focusing filters, all of which are well known in the art, is included in the scanning apparatus.

Body section 704 houses the main computing elements of the laptop computer. These elements generally include the CPU 720, power unit 722, hard drive 724, I/O ports 726 (USB, phone/modem, Ethernet, SCSI, HDMI, PCMCIA etc), RAM 728, video/audio card 730, all connected via a common bus 732. In addition, the body section 704 includes an integrated roller unit 705 which includes the roller or rollers 706, a motor 707, a sensing device 709 (in some embodiments of the invention) for sensing the insertion of a medium to be scanned and monitor position locator 711, featured in some embodiments of the invention for assisting in optimally positioning the monitor for scanning. The scanning apparatus and roller unit are connected to the internal systems of the laptop via the common bus 732. Operation of the integrated scanning apparatus and roller unit is controlled by the hardware, firmware and software or any applicable combination thereof. In use, a medium to be scanned passes through aperture 710 defined by the monitor section 702 thereabove, the body section 704 therebelow and the hinges 718.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A sheet-fed scanner integral to a laptop computer, comprising:
a. a scanning apparatus embedded in a hinged edge of a monitor of the laptop computer; and
b. a roller assembly operationally coupled to a body of the laptop computer, whereby said roller assembly is operative to propel a medium to be scanned beneath said scanning apparatus.

2. The scanner of claim 1 wherein said scanning apparatus includes:
(i) a scanner lamp for illuminating said medium as said roller assembly propels said medium beneath said scanning apparatus;
(ii) an image sensor; and
(iii) an optical system for projecting an illuminated image from said illuminated medium onto said image sensor.

3. The scanner of claim 2 wherein the image sensor is a Charge-Coupled Device (CCD) array.

4. The scanner of claim 1 wherein said scanning apparatus is a Contact Image Sensor (CIS).

5. The scanner of claim 1 wherein said roller assembly includes:
(i) motor; and
(ii) at least one roller operationally coupled to said motor.

6. The scanner of claim 1 further including:
c. a monitor position locator, for accurately positioning said laptop monitor substantially perpendicular to said laptop body, to enhance scanning quality.

7. The scanner of claim 6 wherein said monitor position locater includes a threaded hinge clickably delineating said substantially perpendicular position.

8. The scanner of claim 6 wherein said monitor position locator includes at least one reference indicator for indicating that said laptop monitor is in said substantially perpendicular position.

9. The scanner of claim 8 wherein said at least one reference indicator is digitally displayed on said monitor.

10. The scanner of claim 8 wherein said at least one reference indicator is located on the laptop computer.
